(19) United States
(12) Patent Application Publication
(10) Pub. No.: US 2005/0246463 A1
(43) Pub. Date: Nov. 3, 2005

(54) Transparent high-speed multistage arbitration system and method

(75) Inventor: Brian David Barrick, Pflugerville, TX (US)

Correspondence Address: Gregory W. Carr;670 Founders Square, 900 Jackson Street, Dallas, TX, 75202, US

(73) Assignee: International Business Machines Corporation, Armonk, NY (US)

(21) Appl. No.: 10/835,348

(22) Filed: Apr. 29, 2004

(51) Int. Cl. G06F 13/00

(52) U.S. Cl. 710/242

(57) ABSTRACT

The present invention provides for a system for allocating resources in a multiprocessor environment. Blocking logic is configured to receive at least a request for resources from a device and to block repeat requests from the device. A first arbiter is coupled to the blocking logic and configured to receive a request for resources and a tag uniquely identifying the device, to perform a first arbitration, and to transmit the request and the tag to a first requester, based on the first arbitration. The first requestor is coupled to the first arbiter and configured to receive a request for resources and a tag from the first arbiter, to transmit the request and the tag to a second arbiter, and to receive a first grant signal from the second arbiter. The second arbiter is coupled to the first requester and configured to receive a request for resources and a tag from the first requester, to perform a second arbitration, to generate a first grant signal based on the second arbitration, and to transmit the first grant signal to the first requester.

### TECHNICAL FIELD

The present invention relates generally to the field of computer resource management and, more particularly, to a system and method for transparent high-speed multistage arbitration.

### BACKGROUND

Modern computer systems often include a plurality of devices that use one or more system resources. In many computer systems one or more devices share a particular resource, and each device is configured to request access to a shared resource and receive a grant or permission before accessing the shared resource. However, typical resources are often configured to perform only one task or operation at a time. Additionally, some resources receive many more requests that can be processed or granted in a given time or cycle.

Thus, modern computer systems often employ arbitration mechanisms to determine which of a number of devices will be allowed access to a particular resource at a given time. However, modern arbitration methods and systems often incur delays in processing due to latency or other inefficiencies in allocating system resources. Moreover, typical arbitration approaches do not allow a large number of devices to participate and still meet their timing requirements. One approach to reducing arbitration delays includes dividing arbitration requests into one or more stages. However, typical staged arbitration methods add complexity in allowing devices to track the arbitration structure and status of their requests, which causes difficulties in arbitration pipelining.

Therefore, there is a need for a system and/or method for transparent high-speed multi-stage arbitration that addresses at least some of the problems and disadvantages associated with conventional systems and methods.

### SUMMARY

The present invention provides a system for allocating resources in a multiprocessor environment. Blocking logic is configured to receive at least a request for resources from a device and to block repeat requests from the device. A first arbiter is coupled to the blocking logic and configured to receive a request for resources and a tag uniquely identifying the device, to perform a first arbitration, and to transmit the request and the tag to a first requester, based on the first arbitration. The first requestor is coupled to the first arbiter and configured to receive a request for resources and a tag from the first arbiter, to transmit the request and the tag to a second arbiter, and to receive a first grant signal from the second arbiter. The second arbiter is coupled to the first requestor and configured to receive a request for resources and a tag from the first requester, to perform a second arbitration, to generate a first grant signal based on the second arbitration, and to transmit the first grant signal to the first requester.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram depicting a transparent high-speed multistage arbitration system;

FIG. 2 is a flow diagram depicting a transparent high-speed multistage arbitration method;

FIG. 3 is a timing diagram depicting an example operation of a transparent high-speed multistage arbitration system; and

FIG. 4 is a timing diagram depicting another example operation of a transparent high-speed multistage arbitration system.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, user interface or input/output techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or in some combinations thereof. In a preferred embodiment, however, the functions are performed by a processor such as a computer or an electronic data processor in accordance with code such as computer program code, software, and/or integrated circuits that are coded to perform such functions, unless indicated otherwise.

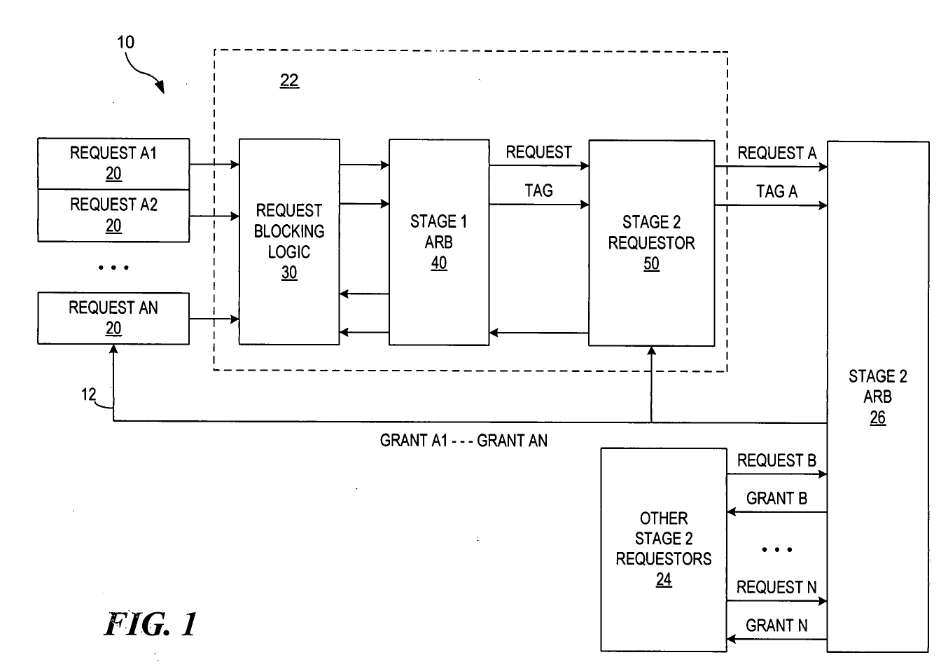

Referring to FIG. 1 of the drawings, the reference numeral 10 generally designates an arbitration system. Arbitration system 10 includes a plurality of devices 20, a multistage arbiter 22, one or more stage two (S2) requesters 24, and a stage two (S2) arbiter 26. In one embodiment, various components or arbitration system 10, in particular multistage arbiter 22, S2 requester 24, and S2 arbiter 26, are electronic circuits embedded on a microchip. Moreover, to simplify explanation and for ease of understanding, the components of arbitration system 10 and their operation will be described with respect to a high-speed multiprocessor environment.

Devices 20 are any devices suitable to be configured to generate and transmit a request for system resources and to receive grant information, such as, for example, a processor, an input/output (I/O) device, and/or other suitable device. It will be understood to one skilled in the art that other suitable devices can also be employed. Generally, system resources are system components that are configured to be accessed or operated by one or more devices and include, for example, shared memory, storage devices, shared processors, busses and other interconnection topology, and other suitable system components. It will be understood to one skilled in the art that other suitable system resources can also be employed.

Multistage arbiter 22 is a processor or other device suitable to be configured to receive requests for system resources, arbitrate received requests, and request resource allocation from an arbiter, such as, for example, S2 arbiter 26. S2 arbiter 26 is a processor or other device suitable to be configured to receive requests for system resources, arbitrate received requests, and allocate system resources based on the received requests. S2 requesters 24 are any devices suitable to be configured to request system resource allocation from an arbiter, such as, for example S2 arbiter 26. In one embodiment, one or more S2 requestors 24 are a multistage arbiter, such as, for example, multistage arbiter 22. In an alternate embodiment, one or more S2 requesters 24 are devices, such as, for example, devices 20. To simplify explanation, arbitration system 10 is depicted with one multistage arbiter 22 and one S2 requester 24. It will be understood to one skilled in the art that other configurations can also be employed, including, for example, a plurality of multistage arbiters 22, a plurality of S2 requestors 24, or other suitable configuration.

In the illustrated embodiment, the various components of arbitration system 10 are depicted as coupled together through a plurality of communication channels 12. Communication channels 12 are any links suitable to be configured to connect one or more microprocessor components, such as, for example, copper wire, optical fiber, a metallic channel embedded in or on an integrated circuit or other chip, or other suitable link. In particular, devices 20 are coupled to multistage arbiter 22 and S2 arbiter 26. S2 arbiter 26 is also coupled to S2 requester 24.

Arbitration system 10 includes multistage arbiter 22. Multistage arbiter 22 includes blocking logic 30, stage one (S1) arbiter 40, and stage two (S2) requestor 50. Blocking logic 30 is coupled to S1 arbiter 40 and is a processor or other device suitable to be configured to receive requests for system resources from a device, to generate stage-one requests, and to transmit stage-one requests to S1 arbiter 40.

S1 arbiter 40 is coupled to S2 requester 50 and is a processor or other device suitable to be configured to receive stage-one requests for system resources, to arbitrate received stage-one requests, to generate a tag based on the device requesting system resources, to generate a stage-two request for system resources based on a tag and received requests, to transmit a stage-two request to an S2 requester, and to receive slot availability information from an S2 requestor. Generally, a tag is a signal that uniquely identifies a device.

S2 requestor 50 is coupled to S2 arbiter 26 and is a processor or other device suitable to be configured to transmit slot availability information to an S1 arbiter, to receive stage-two requests, to queue stage-two requests, to transmit stage-two requests to an S2 arbiter, and to receive grant information. In the illustrated embodiment, S2 requestor 50 is configured to transmit one stage-two request to an S2 arbiter and to queue one stage-two request for transmission after the previously transmitted stage-two request is resolved. Accordingly, S2 requester 50 is described herein as including two “slots,” representing the ability to transmit one request (the first slot) and queue another (the second slot). It will be understood to one skilled in the art that S2 requester 50 can be configured with any number of slots. Slot availability information, as used herein, is information indicating whether a slot is available on S2 requestor 50, that is, whether S2 requester 50 has resources available to receive a stage-two request from S1 arbiter 40.

In operation, as described in more detail below, multistage arbiter 22 receives requests for system resources from one or more devices 20, arbitrates which device 20 has priority for system resources over competing devices 20 (that is, which device 20 wins the arbitration), generates a tag, and sends the tag and the request of the winning device 20 to S2 arbiter 26. In particular, blocking logic 30 receives requests from one or more devices 20 and determines whether the request is a repeat request. Generally, a repeat request is a request for system resources made by a device that has previously requested, but has not yet been granted, access to the same system resources.

If a request is not a repeat request, blocking logic 30 passes the request to S1 arbiter 40. If a request is a repeat request, blocking logic 30 does not pass the request to S1 arbiter 40. In one embodiment, blocking logic 30 can be configured to pass a repeat request to a ground or null destination. In an alternate embodiment, blocking logic 30 is configured to block a repeat request only after the request has won a stage-one arbitration, as described in more detail below.

S1 arbiter 40 receives requests from blocking logic 30 and arbitrates competing requests. Generally, arbitration is a process or method that resolves competing requests for resources, to determine which device will be granted access to the resource in question, or in the absence of competing requests, grants access to the requested resource. Generally, competing requests are requests from different devices requesting access to the same system resource at the same time. S1 arbiter 40 can be configured to arbitrate competing requests in various ways, such as, for example, device-priority arbitration, request-age arbitration, round-robin arbitration, or other suitable arbitration.

Generally, device-priority arbitration arbitrates competing requests based on a priority of the requesting device and request-age arbitration arbitrates competing requests based on the length of time that has passed since the request was first received. Generally, round-robin arbitration arbitrates competing requests based on a priority of the requesting device, where the priority of a given device relative to other devices varies over time, with each device assigned the highest priority in turn. In the illustrated embodiment, S1 arbiter 40 arbitrates competing requests using a request-age arbitration. It will be understood to one skilled in the art that other arbitration methods can also be employed. In the illustrated embodiment, S1 arbiter 40 is configured to perform one arbitration per clock cycle. It will be understood to one skilled in the art that S1 arbiter 40 can also be configured to perform more than one arbitration per clock cycle, or otherwise suitably configured.

S1 arbiter 40 generates a stage-two request based on the received stage-one requests and the outcome of the arbitration. S1 arbiter 40 also generates a tag identifying the specific device 20 that has won an arbitration. In one embodiment, S1 arbiter 40 generates a tag after a device 20 has won an arbitration. In an alternate embodiment, S1 arbiter 40 generates a tag identifying the specific device 20 that is requesting resources after the request is received from blocking logic 30, regardless of whether the specific device 20 has won an arbitration. In an alternate embodiment, blocking logic 30 is configured to generate a tag identifying the specific device 20 that is requesting resources, and to transmit the tag and the request to S1 arbiter 40. In an alternate embodiment, each device 20 is configured to generate and transmit a tag with its request to blocking logic 30.

S1 arbiter 40 also receives slot availability information from S2 requestor 50. If a slot is available on S2 requester 50, S1 arbiter 40 transmits the stage-two request and the tag to S2 requestor 50. As described above, once S1 arbiter 40 transmits the stage-two request and the tag to S2 requestor 50, S1 arbiter 40 transmits a grant to blocking logic 30, after which blocking logic 30 blocks repeat requests.

If no slot is available, S1 arbiter 40 will wait until a slot becomes available. In the illustrated embodiment, S1 arbiter 40 transmits the stage-two request and the tag as separate elements through separate communication channels 12. In an alternate embodiment, S1 arbiter 40 combines the stage-two request and tag into a combined request and transmits the combined request to S2 requestor 50. S1 arbiter 40 can also be configured to generate the stage-two request based on the received stage-one requests, the outcome of the arbitration, and the tag, and transmit the stage-two request to S2 requestor 50.

S2 requestor 50 receives the stage-two request and the tag and transmits the stage-two request and the tag to S2 arbiter 26. S2 requester 50 can also be configured to generate a tag identifying the specific device 20 that is requesting access to system resources, and to transmit the stage-two request and the tag to S2 arbiter 26. As described above, in the illustrated embodiment, S2 requestor 50 is configured to include two slots, a first slot, used to transmit a first stage-two request and tag to S2 arbiter 26, and a second slot, used to queue a second stage-two request and tag. When the first stage-two request is resolved, such as, for example, by a grant of access to the requested resources, S2 requestor 50 transmits the second stage-two request and tag to S2 arbiter 26. With the first stage-two request resolved, a slot is now available and S2 requestor 50 is able to queue a third stage-two request and tag. Accordingly, S2 requester 50 sends slot availability information to S1 arbiter 40. In a particular embodiment, S2 requestor 50 is configured to transmit stage-two requests and tags every clock cycle, and to receive requests from S1 arbiter 40 every other clock cycle. In an alternate embodiment, S2 requester 50 is configured to transmit stage-two requests and tags every other clock cycle.

As illustrated, S2 requestor 50 is configured to send slot availability information to S1 arbiter 40 during each clock cycle a slot is available. In an alternate embodiment, S1 arbiter 40 is configured to query S2 requestor 50 whether a slot is available and S2 requestor 50 is configured to send slot availability information to S1 arbiter 40 in response to a query. It will be understood to one skilled in the art that other suitable configurations can also be employed.

As illustrated, multistage arbiter 22 is configured to perform one arbitration with two stages, that is, an arbitration stage and a stage-two request stage. In an alternate embodiment, multistage arbiter 22 can be configured to perform more than one arbitration with more than two stages. For example, multistage arbiter 22 can include a stage two arbiter coupled to S2 requestor 50 and a stage three requester coupled to the stage two arbiter, where the stage three requestor is also coupled to a stage three arbiter external to multistage arbiter 22. It will be understood to one skilled in the art that other suitable configurations can also be employed.

Arbitration system 10 also includes stage two (S2) arbiter 26. S2 arbiter 26 is a processor or other device suitable to be configured to receive requests for system resources, arbitrate received requests, and allocate system resources based on the received requests. As described above, where multistage arbiter 22 is configured to perform more than one arbitration, S2 arbiter 26 can be configured as a stage three arbiter. Generally, the designation of an arbiter as a particular stage arbiter, such as, for example, “stage one” or “stage two,” does not restrict the arbiter's functionality. It will be understood to one skilled in the art that the stage designation is merely a helpful description to indicate where, in a system that employs multistage arbitration, the particular arbiter operates with respect to earlier or later performed arbitrations.

Generally, in operation, S2 arbiter 26 receives requests for access to system resources from multistage arbiter 22 and one or more S2 requesters 24 and arbitrates competing requests. In the illustrated embodiment, S2 arbiter 26 arbitrates competing requests using a device-priority arbitration. It will be understood to one skilled in the art that other arbitration methods can also be employed. In the illustrated embodiment, S2 arbiter 26 is configured to perform one arbitration per clock cycle. It will be understood to one skilled in the art that S2 arbiter 26 can also be configured to perform one arbitration over more than one clock cycle, more than one arbitration per clock cycle, or otherwise suitably configured.

In an example operation, S2 arbiter 26 receives a request (Request A) and a tag from multistage arbiter 22 and a competing request (Request B) from S2 requestor 24. S2 arbiter 26 arbitrates the competing requests and determines which request to grant. If Request B is granted, S2 arbiter 26 sends a grant signal to S2 requester 24. If Request A is granted, S2 arbiter 26 sends a grant signal to multistage arbiter 22 (in particular, S2 requestor 50) and to the device 20 that originally requested access, based on the tag. Thus, the tag allows the multistage arbitration process to be transparent to the originally requesting device. As the S1 grant is not transmitted to the originally requesting device, as described above, the originally requesting device only receives a grant when the device wins access to the requested resources, rather than multiple grant signals indicating an arbitration won at a stage before the final arbitration. Moreover, multistage arbiter 22 allows the devices and other requesters to operate as if connected to a single arbitration point, where all requests are arbitrated together, also allowing arbitration for the resource to be pipelined.

Generally, a grant signal is signal to a device, notifying that device that its request for access to system resources has been granted. Alternately, a grant signal can be a signal to a system resource, notifying that resource that a particular device has access to the resource, that is, a particular device is the active participant on the resource. Alternatively, a grant signal can be a signal to one or more components of the system, notifying the components that a particular device is the active participant on the resource. It will be understood to one skilled in the art that other configurations can also be employed.

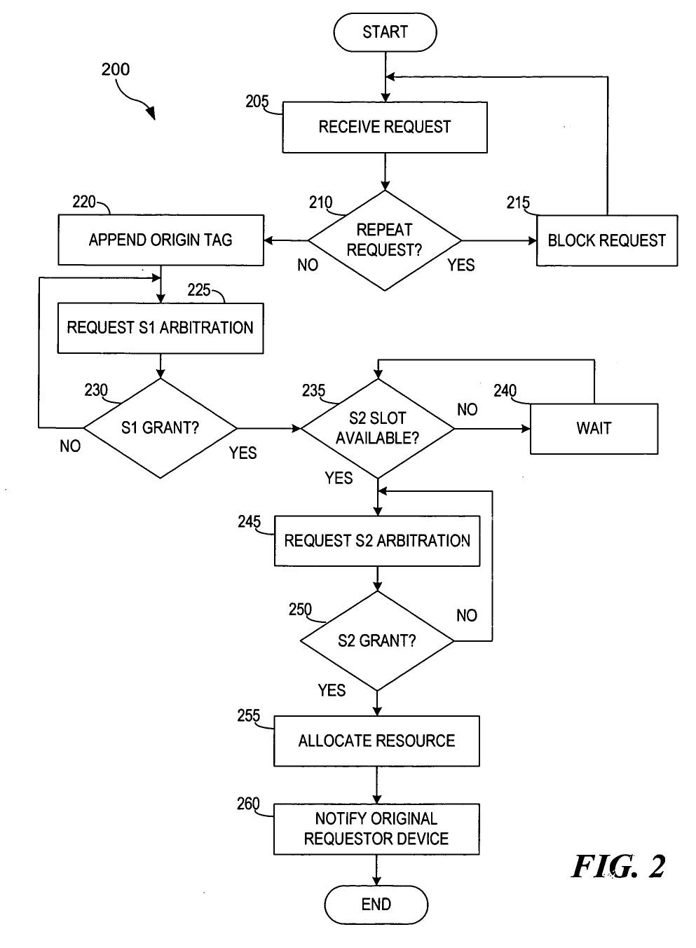

Referring now to FIG. 2 of the drawings, the reference numeral 200 generally designates a flow chart depicting the operation of a transparent high-speed multistage arbitration system, such as, for example, arbitration system 10 of FIG. 1. The process begins at step 205, wherein a request for system resources is received. This step can be performed by, for example, blocking logic 30 of FIG. 1. Next, at decisional step 210, a determination is made whether the request received in step 205 is a repeat request. This step can be performed by, for example, blocking logic 30 of FIG. 1.

If at decisional step 210 the request is a repeat request, the process continues along the YES branch to step 215. At step 215, the repeat request is blocked and/or shunted and the process returns to step 205. This step can be performed by, for example, blocking logic 30 of FIG. 1. If at decisional step 210 the request is not a repeat request, the process continues along the NO branch to step 220.

At step 220, a tag is generated, identifying the specific device that is requesting access to system resources, and the tag is appended to the request. This step can be performed by, for example, blocking logic 30 and/or S1 arbiter 40 of FIG. 1. Where the tag is generated by S1 arbiter 40, this step can be combined with step 245, as described below.

At step 225, S1 arbitration is requested. This step can be performed by, for example, blocking logic 30 of FIG. 1. Next, at decisional step 230, a determination is made whether the request has won the S1 arbitration. In one embodiment, the determination is based on whether an S1 grant is received from the S1 arbiter, and this step is performed by, for example, blocking logic 30 of FIG. 1. In an alternate embodiment, this step is performed by, for example, S1 arbiter 40 of FIG. 1, and this step can include generating and transmitting a grant signal to blocking logic 30.

If at decisional step 230 the request has not won the S1 arbitration, the process continues along the NO branch and returns to step 225, wherein S1 arbitration is requested. If at decisional step 230 the request has won the S1 arbitration, the process continues along the YES branch to decisional step 235. At decisional step 235, a determination is made whether an S2 requester slot is available. This step can be performed by, for example, S2 requester 50 of FIG. 1. In an alternate embodiment, this step can be performed by S1 arbiter 40 querying S2 requester 50 of FIG. 1.

If at decisional step 235 an S2 requestor slot is not available, the process continues along the NO branch to step 240. At step 240, the process waits. This step can be performed by, for example, S1 arbiter 40 of FIG. 1. It will be understood to one skilled in the art that one or more other processes or operations can continue during step 240. Moreover the amount of time that comprises the wait period can be zero seconds, negligible, one clock cycle, or many clock cycles or portions of a clock cycle. After step 240, the process returns to decisional step 235.

If at decisional step 235 an S2 requester slot is available, the process continues along the YES branch to step 245. At step 245, S2 arbitration is requested. This step can be performed by, for example, S2 requestor 50 of FIG. 1. This step includes sending the request and tag to an S2 arbiter, such as, for example S2 arbiter 26 of FIG. 1. Next, at decisional step 250, a determination is made whether the request has won the S2 arbitration. In one embodiment, the determination is based on whether an S2 grant signal is received from the S2 arbiter, and this step is performed by, for example, S2 requestor 50 of FIG. 1. In an alternate embodiment, this step is performed by, for example, S2 arbiter 26 of FIG. 1, and this step can include generating and transmitting a grant signal to S2 requester 50. In an alternate embodiment, this step can include notifying S1 arbiter 40 that an S2 requestor slot is available when S2 requestor 50 receives a grant signal from S2 arbiter 26, and can be performed by S2 requestor 50 of FIG. 1.

If at decisional step 250 the request has not won the S2 arbitration, the process continues along the NO branch and returns to step 245, wherein S2 arbitration is requested. If at decisional step 250 the request has won the S2 arbitration, the process continues along the YES branch to step 255. At step 255, the system resources requested in the request are allocated to the device that made the original request (received in step 205). This step can be performed by, for example, S2 arbiter 26 of FIG. 1. In one embodiment, this step includes notifying the specific system resources that the requesting device is the active participant on the resource.

Next, at step 260, the original requesting device is notified that it has access to the system resources it requested, and the process ends. This step can be performed by, for example, S2 arbiter 26 of FIG. 1. It will be understood to one skilled in the art that this step can be combined with step 255, performed before step 255, or, as described above, can be the method by which the resource is allocated.

Additionally, it will be understood to one skilled in the art that the various steps above may be combined and that one or more steps may be skipped, or additional steps added, without departing from the spirit of the present invention. For example, in one embodiment, devices are configured to make continuous requests for system resources. Thus, for example, a request is received in step 205 at clock cycle X, the request is determined not to be a repeat request in step 210 at clock cycle X+1, and is processed accordingly, the request is again received in step 205 at clock cycle X+1, is determined to be a repeat request in step 210, and blocked in step 215, at clock cycle X+2, and so forth. A similar pattern can occur with respect to steps 225 and 230, steps 235 and 240, and steps 245 and 250. It will be understood to one skilled in the art that other combinations or configurations can also be employed.

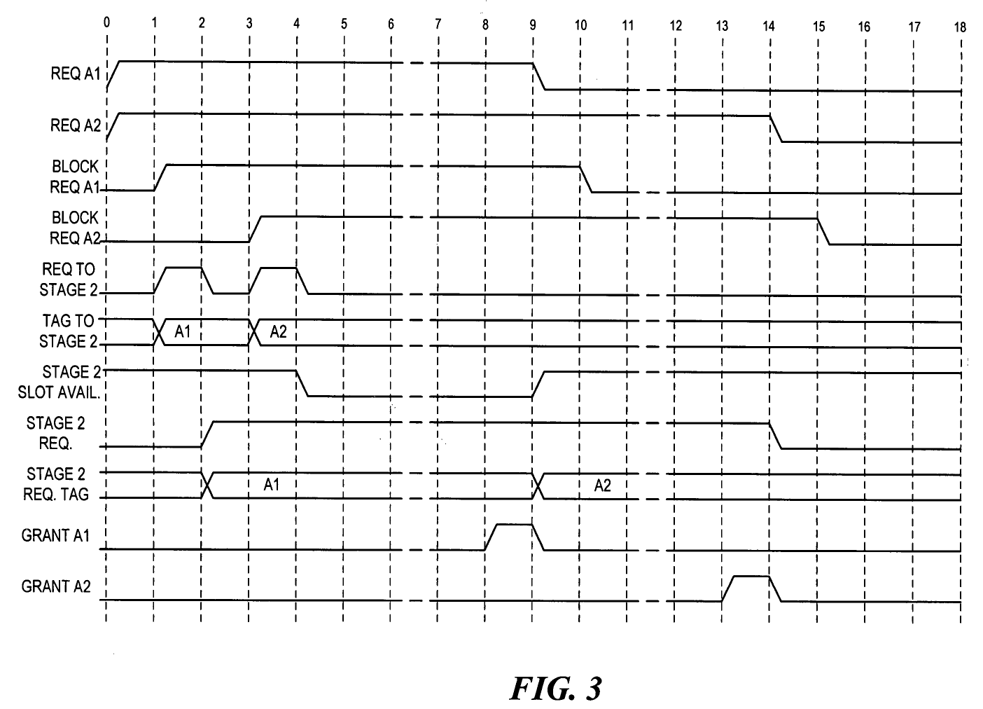

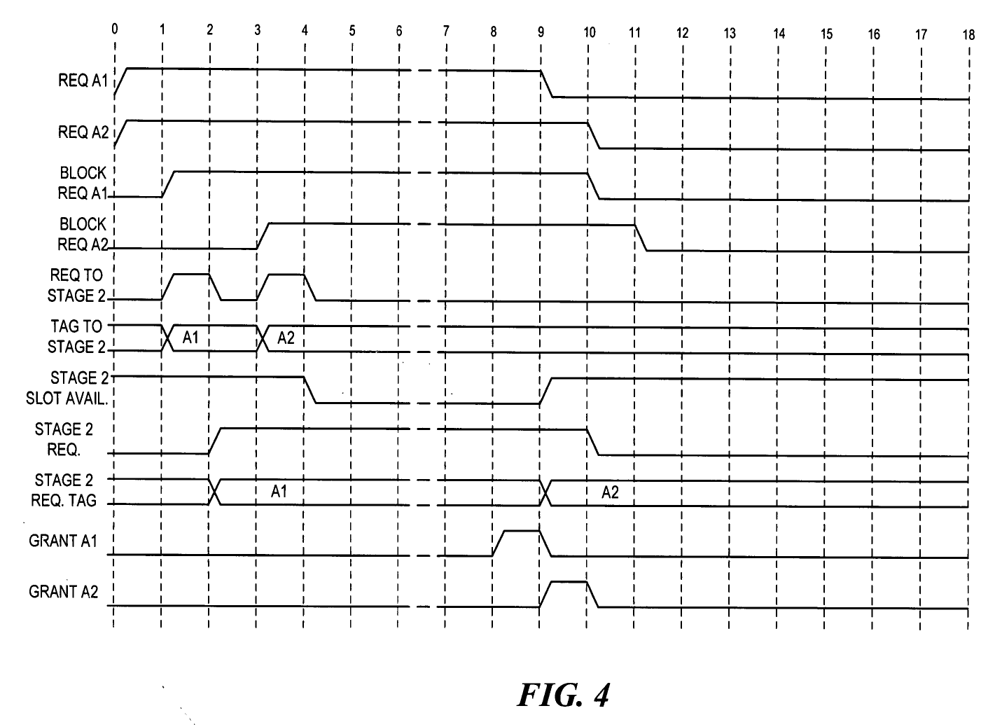

FIGS. 3 and 4 are timing diagrams illustrating example operations of an arbitration system, such as, for example, arbitration system 10 of FIG. 1. In particular, FIGS. 3 and 4 illustrate example operations in an arbitration system wherein the various components are embodied as electronic circuits and requests for system resources, tags, grant signals, and other signals are embodied as a logic low (or zero) or logic high (or one). Moreover, for ease of illustration, FIGS. 3 and 4 will be described with respect to components of arbitration system 10 of FIG. 1, where appropriate.

Referring now to FIG. 3, at time 0, device A1 and device A2 request access to system resources and the signals “REQ A1” and “REQ A2” transition from low to high. At time 0, two slots are available on S2 requestor 50, and the signal “STAGE 2 SLOT AVAIL.” is high. At time 1, S1 arbiter 40 grants access to device A1, and passes the request (request A1) and a tag identifying device A1 (tag A1) to S2 requestor 50. Accordingly, the signal “BLOCK REQ A1” transitions from low to high, remaining high until device A1 receives a final grant to access the requested resources, as described below. Signal “REQ TO STAGE 2” also transitions from low to high at time 1. Signal “TAG TO STAGE 2” also transitions to indicate the tag A1 to S2 requestor 50.

At time 2, S2 requester 50 sends request A1 and tag A1 to S2 arbiter 26. Accordingly, signal “STAGE TWO REQ.” transitions from low to high, remaining high until all pending stage-two requests are granted, as described below. Signal “REQ TO STAGE 2” transitions from high to low at time 1, indicating that request A1 and tag A1 have been sent to S2 arbiter 26. Signal “STAGE 2 REQ. TAG” also transitions to indicate the tag A1 to S2 arbiter 26.

At time 3, S1 arbiter 40 grants access to device A2 and passes the request (request A2) to S2 requester 50. Accordingly, the signal “BLOCK REQ A2” transitions from low to high, remaining high until device A2 receives a final grant to access the requested resources, as described below. Also at time 3, S1 arbiter 40 sends a tag identifying device A2 (tag A2) to S2 requestor 50. Accordingly, signal “TAG TO STAGE 2” transitions to indicate the tag A2 to S2 requester 50 and signal “REQ TO STAGE 2” transitions from low to high.

At time 4, S2 requester 50 now has one request awaiting a grant from S2 arbiter 26 (request A1) and one request and tag ready to send to S2 arbiter 26 (request A2 and tag A2) when request A1 is granted. Accordingly, S2 requestor 50 has no available slots and signal “STAGE 2 SLOT AVAIL.” transitions from high to low. The system maintains this state until request A1 is granted.

At time 8, S2 arbiter 26 grants access to device A1. Accordingly, signal “GRANT A1” transitions from low to high. At time 9, since device A1 now has access to the requested resources, it no longer needs to request those resources, and, accordingly, signal “REQ A1” transitions from high to low. Signal “GRANT A1” also transitions from high to low. As request A1 has been granted, S2 requestor 50 can now send request A2 and tag A2 to S2 arbiter 26. Accordingly, signal “STAGE 2 REQ.” remains high and signal “STAGE 2 REQ. TAG” transitions to indicate tag A2 to S2 arbiter 26. As a slot is now available on S2 requestor 50, signal “STAGE 2 SLOT AVAIL.” transitions from low to high. At time 10, as device A1 is no longer requesting access to system resources, blocking logic 30 no longer needs to block the request. Accordingly, signal “BLOCK REQ A1” transitions from high to low. The system maintains this state until request A2 is granted (or device A1 makes another request).

At time 13, S2 arbiter 26 grants access to device A2. Accordingly, signal “GRANT A2” transitions from low to high. At time 14, since device A2 now has access to the requested resources, it no longer needs to request those resources, and, accordingly, signal “REQ A2” transitions from high to low. Signal “GRANT A2” also transitions from high to low. As request A2 has been granted, S2 requester 50 now has no pending requests. Accordingly, signal “STAGE 2 REQ.” transitions from high to low. At time 15, as device A2 is no longer requesting access to system resources, blocking logic 30 no longer needs to block the request. Accordingly, signal “BLOCK REQ A2” transitions from high to low.

Referring now to FIG. 4, at time 0, device A1 and device A2 request access to system resources and the signals “REQ A1” and “REQ A2” transition from low to high. At time 0, two slots are available on S2 requester 50, and the signal “STAGE 2 SLOT AVAIL.” is high. At time 1, S1 arbiter 40 grants access to device A1, and passes the request (request A1) and a tag identifying-device A1 (tag A1) to S2 requester 50. Accordingly, the signal “BLOCK REQ A1” transitions from low to high, remaining high until device A1 receives a final grant to access the requested resources, as described below. Signal “REQ TO STAGE 2” also transitions from low to high at time 1. Signal “TAG TO STAGE 2” also transitions to indicate the tag A1 to S2 requestor 50.

At time 2, S2 requestor 50 sends request A1 and tag A1 to S2 arbiter 26. Accordingly, signal “STAGE TWO REQ.” transitions from low to high, remaining high until all pending stage-two requests are granted, as described below. Signal “REQ TO STAGE 2” transitions from high to low at time 1, indicating that request A1 and tag A1 have been sent to S2 arbiter 26. Signal “STAGE 2 REQ. TAG” also transitions to indicate the tag A1 to S2 arbiter 26.

At time 3, S1 arbiter 40 grants access to device A2 and passes the request (request A2) to S2 requester 50. Accordingly, the signal “BLOCK REQ A2” transitions from low to high, remaining high until device A2 receives a final grant to access the requested resources, as described below. Also at time 3, S1 arbiter 40 sends a tag identifying device A2 (tag A2) to S2 requestor 50. Accordingly, signal “TAG TO STAGE 2” transitions to indicate the tag A2 to S2 requester 50 and signal “REQ TO STAGE 2” transitions from low to high.

At time 4, S2 requester 50 now has one request awaiting a grant from S2 arbiter 26 (request A1) and one request and tag ready to send to S2 arbiter 26 (request A2 and tag A2) when request A1 is granted. Accordingly, S2 requestor 50 has no available slots and signal “STAGE 2 SLOT AVAIL.” transitions from high to low. The system maintains this state until request A1 is granted.

At time 8, S2 arbiter 26 grants access to device A1. Accordingly, signal “GRANT A1” transitions from low to high. At time 9, since device A1 now has access to the requested resources, it no longer needs to request those resources, and, accordingly, signal “REQ A1” transitions from high to low. Signal “GRANT A1” also transitions from high to low. As request A1 has been granted, S2 requester 50 can now send request A2 and tag A2 to S2 arbiter 26. Accordingly, signal “STAGE 2 REQ.” remains high and signal “STAGE 2 REQ. TAG” transitions to indicate tag A2 to S2 arbiter 26. As a slot is now available on S2 requestor 50, signal “STAGE 2 SLOT AVAIL.” transitions from low to high. At time 10, as device A1 is no longer requesting access to system resources, blocking logic 30 no longer needs to block the request. Accordingly, signal “BLOCK REQ A1” transitions from high to low. The system maintains this state until request A2 is granted (or device A1 makes another request).

In this case, S2 arbiter 26 grants access to device A2 at time 9. Accordingly, signal “GRANT A2” transitions from low to high. At time 10, since device A2 now has access to the requested resources, it no longer needs to request those resources, and, accordingly, signal “REQ A2” transitions from high to low. Signal “GRANT A2” also transitions from high to low. As request A2 has been granted, S2 requestor 50 now has no pending requests. Accordingly, signal “STAGE 2 REQ.” transitions from high to low. At time 11, as device A2 is no longer requesting access to system resources, blocking logic 30 no longer needs to block the request. Accordingly, signal “BLOCK REQ A2” transitions from high to low.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A system for allocating resources in a multiprocessor environment, comprising:
blocking logic configured to receive at least a request for resources from a device and to block repeat requests from the device;
a first arbiter coupled to the blocking logic and configured to receive a request for resources and a tag uniquely identifying the device, to perform a first arbitration, and to transmit the request and the tag to a first requestor, based on the first arbitration;
the first requestor coupled to the first arbiter and configured to receive a request for resources and a tag from the first arbiter, to transmit the request and the tag to a second arbiter, and to receive a first grant signal from the second arbiter; and
the second arbiter coupled to the first requestor and configured to receive a request for resources and a tag from the first requester, to perform a second arbitration, to generate a first grant signal based on the second arbitration, and to transmit the first grant signal to the first requester.

2. The system as recited in claim 1, wherein:
the first requester is further configured to generate a slot availability signal and to transmit the slot availability signal to the first arbiter; and
the first arbiter is further configured to receive the slot availability signal from the first requestor and to transmit the request and the tag to the first requester, based on the first arbitration and the slot availability signal.

3. The system as recited in claim 1, wherein the blocking logic is further configured to receive a tag from the device and to transmit the tag to the first arbiter, the tag uniquely identifying the device.

4. The system as recited in claim 1, wherein the blocking logic is further configured to generate a tag uniquely identifying the device and to transmit the tag to the first arbiter.

5. The system as recited in claim 1, wherein the first arbiter is further configured to generate a tag uniquely identifying the device.

6. The system as recited in claim 1, wherein the second arbiter is further configured to allocate resources based on the second arbitration.

7. The system as recited in claim 1, wherein the second arbiter is further configured to transmit the first grant signal to the device.

8. The system as recited in claim 1, wherein the second arbiter is further configured to generate a second grant signal based on the second arbitration and the tag and to transmit the second grant signal to the device.

9. The system as recited in claim 1, wherein the second arbiter is further configured to transmit the request and the tag to a second requester, based on the second arbitration.

10. The system as recited in claim 9, further comprising:
a second requestor coupled to the second arbiter and configured to receive a request for resources and a tag from the second arbiter, to transmit the request and the tag to a third arbiter, and to receive a third grant signal from the third arbiter; and
the third arbiter coupled to the second requester and configured to receive a request for resources and a tag from the second requester, to perform a third arbitration, to generate a third grant signal based on the third arbitration, and to transmit the third grant signal to the second requester.

11. The system as recited in claim 10, wherein the third arbiter is further configured to allocate resources based on the third arbitration.

12. The system as recited in claim 10, wherein the third arbiter is further configured to transmit the third grant signal to the device.

13. The system as recited in claim 10, wherein the third arbiter is further configured to generate a fourth grant signal based on the third arbitration and the tag and to transmit the fourth grant signal to the device.

14. A method for transparent multistage arbitration in a multiprocessor environment, comprising:
receiving a first request for access to resources from a first device;
receiving a first tag, the first tag at least uniquely identifying the first device;
blocking repeat requests from the first device;
performing a first arbitration based on the first request;
requesting a second arbitration based on the first arbitration and the first tag; and
performing a second arbitration based on the first arbitration and the first tag.

15. The method as recited in claim 14, wherein blocking repeat requests from the first device is based on the first arbitration.

16. The method as recited in claim 14, further comprising generating a first tag, the first tag at least uniquely identifying the first device.

17. The method as recited in claim 14, further comprising allocating resources based on the second arbitration.

18. The method as recited in claim 14, further comprising generating a grant signal based on the second arbitration and the first tag.

19. The method as recited in claim 18, further comprising transmitting the grant signal to the first device.

20. The method as recited in claim 14, further comprising requesting a third arbitration based on the second arbitration and the first tag.

21. The method as recited in claim 20, further comprising performing a third arbitration based on the second arbitration and the first tag.

22. The method as recited in claim 14, further comprising:
receiving a second request for access to resources from a second device;
receiving a second tag, the second tag at least uniquely identifying the second device; and
blocking repeat requests from the second device.

23. The method as recited in claim 22, further comprising generating a second tag, the second tag at least uniquely identifying the second device.

24. The method as recited in claim 22, wherein the first arbitration is based on the first request and the second request.

25. The method as recited in claim 24, further comprising requesting a second arbitration based on the first arbitration and the second tag.

26. The method as recited in claim 25, further comprising performing a second arbitration based on the first arbitration and the second tag.

27. The method as recited in claim 22, further wherein blocking repeat requests from the second device is based on the first arbitration.
